(19) United States
(12) Patent Application Publication
(10) Pub. No.: US 2010/0157362 A1
(43) Pub. Date: Jun. 24, 2010

(54) INFORMATION PROCESSING APPARATUS, PRINTING CONTROL METHOD, PROGRAM, AND STORAGE MEDIUM

(75) Inventor: Hiroshi Oomura, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/637,547

(22) Filed: Dec. 14, 2009

(30) Foreign Application Priority Data
Dec. 18, 2008 (JP) 2008-322105

(51) Int. Cl. G06F 15/00

(52) U.S. Cl. 358/1.15

(57) ABSTRACT

In response to a request to open a user interface on which print setting is performed, a printer driver receives a change in print setting value set in initial setting. The printer driver processes a job according to the received print setting value. On the other hand, when a request to open the user interface has not been received, the printer driver performs print setting by using initial setting values set previously in relation to a determining condition that can be obtained from the job.

### BACKGROUND OF THE INVENTION

1. Field of the Invention

The present invention relates to an information processing apparatus configured to process a job using a printer driver.

2. Description of the Related Art

There has been increased consciousness of the reduction of Total Cost of Ownership (TCO) and the protection of ecological balance. The administrators of printing systems are expected to put efforts into reducing the expenditure in costly color printing of documents which need not be printed in color, and encouraging more use of two-page print on a sheet of paper and two-sided printing to decrease paper consumption.

For example, depending on an intended printing application, it is recommendable to permit color printing, one page print on a sheet, and one-sided printing on a sheet for documents for external use, such as written estimate, but other documents for internal use should be printed in monochrome, two-page print on a sheet, and two-sided printing.

According to Japanese Patent Application Laid-Open No. 2007-058746, in printing of documents, conditions, such as a print application name, machine names in a printing environment, a document name, and a color ratio of documents to be printed, are specified, but in printing of documents to which those conditions are not applied, a limitation is imposed on output of color printing. In this way, wasteful, unnecessary color printing is restricted and the amount of consumed color toner can be reduced.

In Japanese Patent Application Laid-Open No. 2007-241489, a user ID and a print execution file name are used as determining conditions, and for combination of items which is impermissible, the print setting is forcibly changed to monochrome printing or cancellation of printing. Color printing can be performed when permission is granted to a print request on the Web or by e-mail.

A conventional system is designed to restrict print setting which induces high cost depending on conditions from a viewpoint of the administrator. When a print setting does not match conditions set by the administrator, even if color printing, one-page a sheet, and one-sided printing are required for business reasons, such a setting may be restricted.

In this case, unless making a specific request to the administrator, general users who perform printing on business basis are unable to obtain color print results necessary for work-related purposes, and they not only feel inconvenience but also are obliged to perform print setting on each print occasion.

In such a printing system, to satisfy both the reduction of TCO and ecological balance and the comfort in business execution, it is desirable to provide a system with a function to assist in print setting by inferring an intended printing application rather than a system that restricts print setting by intervention of the administrator. Even in a case where assistance is employed in print setting based on inference of an intended printing application, it is desirable to provide a print setting environment capable of flexibly adapting to print requests from users.

### SUMMARY OF THE INVENTION

The present invention is directed to an information processing apparatus, which performs print setting adaptable to determining conditions based on initial setting by a simple operation, and which can change print setting in response to a request from a user.

According to an aspect of the present invention, an information processing apparatus including a printer driver configured to generate a job to be output to a printing apparatus is provided. The information processing apparatus includes a print setting unit configured to perform print setting using a function of performing initially-set print setting by inferring an intended printing application according to a determining condition obtained from the job or a function of allowing a user to perform print setting to the job, a determination unit configured to determine whether a user interface operable to change the initially-set print setting is requested from the user, and a control unit configured to process the job based on print setting values changed via the user interface if the determination unit determines that the user interface is requested from the user, and to process the job according to the function of performing initially-set print setting by inferring an intended printing application according to a determining condition obtained from the job if the determination unit determines that the user interface is not requested from the user.

According to another aspect of the present invention, a storage medium stores a program for causing a computer to perform a method including displaying a setting screen on which a specific setting value that is set corresponding to one of a print module name, a print job name, and characters in a page is displayed as an initial value and the specific setting value is allowed to be changed by a user, and, when the specific setting value is not changed via the setting screen, setting a setting value corresponding to one of the print module name, the print job name, and the characters in a page, and when the specific setting value is changed, setting the changed setting value.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of an information processing apparatus according to a first exemplary embodiment of the present invention.

FIG. 2 is a block diagram illustrating a configuration of software of a printing system in FIG. 1.

FIG. 3 is a diagram illustrating an example of a user interface displayed on a monitor in FIG. 1.

FIG. 4 is a diagram illustrating an example of a user interface displayed on the monitor in FIG. 1.

FIG. 5 is a diagram illustrating a relationship between determining conditions and print setting values stored in an external storage device in FIG. 1.

FIG. 6 is a diagram illustrating an example of a processing sequence of an entire printing operation in the information processing apparatus according to the first exemplary embodiment of the present invention.

FIG. 7 is a diagram illustrating an example of a user interface displayed on the monitor in FIG. 1.

FIG. 8 is a flowchart illustrating an example of a data processing procedure in the information processing apparatus according to the first exemplary embodiment of the present invention.

FIG. 9 is a flowchart illustrating an example of a data processing procedure in the information processing apparatus according to the first exemplary embodiment of the present invention.

FIG. 10 is a diagram illustrating a part of the user interface illustrated in FIG. 7.

FIG. 11 is a diagram illustrating a part of the user interface illustrated in FIG. 7.

FIG. 12 is a flowchart illustrating an example of a data processing procedure in an information processing apparatus according to a second exemplary embodiment of the present invention.

FIG. 13 is a diagram illustrating another example of the user interface illustrated in FIG. 7.

FIG. 14 is a flowchart illustrating an example of a data processing procedure according to a third exemplary embodiment of the present invention.

### DESCRIPTION OF THE EMBODIMENTS

Various exemplary embodiments, features, and aspects of the invention will be described in detail below with reference to the drawings.

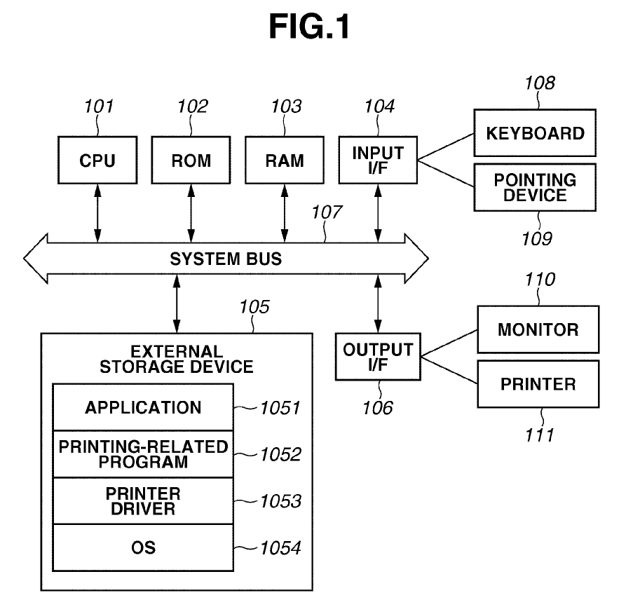

FIG. 1 is a block diagram illustrating a configuration of an information processing apparatus according to a first embodiment of the present invention. This example illustrates a case where a printing processing system is formed using an ordinary computer.

Unless otherwise specified, the present invention can be applied to a system including a plurality of apparatuses and a system which performs processing via a network, such as a LAN, and also to a single device as long as the function of the present invention is implemented.

As illustrated in FIG. 1, a CPU 101 controls the entire apparatus according to a program stored in a ROM 102, a RAM 103, or an external storage device 105. The RAM 103 serves also as a work area where the CPU 101 executes various types of processes.

The external storage device 105 stores an operating system 1054 and application software 1051. A keyboard 108 and a pointing device 109, such as a mouse, are devices by which a user gives various commands to a computer via an input interface (I/F) 104.

An output I/F 106 is an interface to output data to the outside, for example, to a monitor 110 or a printer 111. The printer may be connected not only through a local I/O but through a network, such as a LAN or a WAN.

A common bus 107 is used to exchange data between component units.

The external storage device 105 in FIG. 1 stores the application 1051, a printing-related program 1052, a printer driver 1053, and an operating system (OS) 1054, which are loaded in the RAM 103 and executed by the CPU 101.

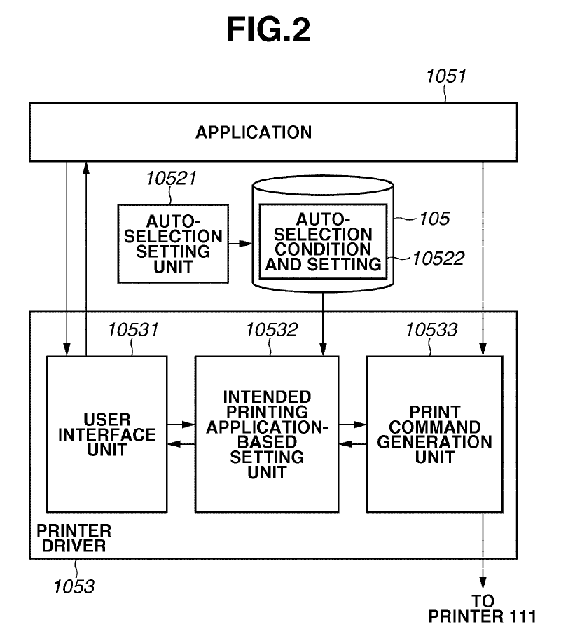

FIG. 2 is a block diagram illustrating the configuration of software for the printing system illustrated in FIG. 1.

In FIG. 2, print processing on the computer is executed chiefly by the application software 1051 and the printer driver 1053. In the present exemplary embodiment, the printer driver 1053 includes an intended printing application-based setting unit for a function of performing initially-set print setting by inferring an intended printing application according to a determining condition obtained from a job, and a user interface unit for print setting by a function of print setting executed by a user to the job.

The printer driver 1053 has a first main role to display a user interface, which will be described below, on the monitor 110 to enable a user to select a printer function, and a second main role to convert a print request from the application software 1051 into a print command.

The printer driver 1053 includes a user interface unit 10531 configured to generate print settings, and a print command generating unit 10533 configured to convert drawn images accompanying print settings in a page into print commands.

Print commands generated by the printer driver 1053 are sent to the printer 111 via the output I/F 106, and images are drawn on print media, such as paper, by the printer 111.

Moreover, in the present exemplary embodiment, the printer driver 1053 further includes an intended printing application-based setting unit 10532.

The intended printing application-based setting unit 10532 is a module which automatically converts print setting values by inferring an intended printing application using information, such as a print module name, a print job name, and a character string in a page. A print module name is an execution module name of the program when the application 1051 performs printing. A print job name is a name of a print job which is set for the job when the application 1051 carries out printing.

As a printing-related program 1052, there is an auto-selection setting unit 10521 configured to register intended printing application determining conditions and print setting values used candidate values when those determining conditions are met.

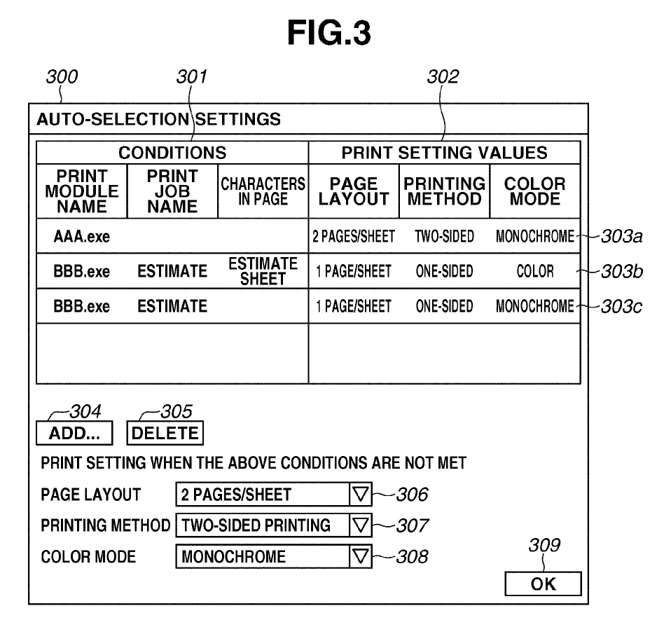

The auto-selection setting unit 10521 receives data output from a user via the user interface illustrated in FIG. 3, and causes the received data to be stored as an auto-selection condition and setting value 10522 in the external storage device 105.

FIG. 3 is a diagram illustrating an example of a user interface displayed on the monitor 110 illustrated in FIG. 1. This example illustrates a case where the auto-selection setting unit 10521 is a setting screen (UI) 300 displayed on the monitor 110

In the present exemplary embodiment, initial setting is performed by using options of specific setting values, including “auto-selection” items as print setting internal information (DEVMODE). On this UI interface, color setting values, which can be selected, for example, 0) auto-selection, (1) monochrome, (2) color, and (3) monochrome/color automatic switch, are provided. For N-up setting, (0) auto-selection, (1) 1-up, (2) 2-up, and (3) 4-up are provided. For two-sided setting, (0) auto-selection, (1) one-sided printing, and (2) two-sided printing are provided.

In Case (1), when a print job including “auto-selection” as a print setting value is received (because a user did not perform setting on the UI), printing is carried out by determining print settings using determining conditions and by solving conflicts and maintaining consistency in print settings. In Case (2), when a print job with values other than “auto-selection” is received (values were set on the UI), printing is performed with those settings.

In FIG. 3, on the setting UI 300 of the auto-selection setting unit 10521, a dialog type setting application is used. As the determining conditions 301 for an intended printing application obtainable from a job, the setting UI 300 include a print module name, a print job name, and a character string in a page to be printed.

As print setting values 302 that can be changed automatically when the determining conditions are met, a page layout, such as 2 pages/sheet, a printing method, such as two-sided printing, and a color mode, such as monochrome, are provided.

In the setting UI 300, this example illustrates a case where auto selection settings 303a to 303c are registered. When auto-selection settings 303a to 303c are collectively referred to, a generic term, “auto-selection setting 303, is used in the following.

The auto-selection setting 303a indicates a case where, when a print module name is AAA.exe, applicable candidates for print setting values are 2 pages/sheet, two-sided printing, and monochrome printing.

If the auto-selection setting 303b includes condition items, such as a print module name of BBB.exe, a print job name of character string “estimate”, and character strings “estimate sheet” in a page, applicable candidates for print setting values are one-page/sheet, one-sided printing, and color printing.

If the auto-selection setting 303c includes a print module name of BBB.exe and a print job name of character string “estimate”, applicable candidates for print setting values are one page/sheet, one-sided printing, and monochrome printing.

Those auto-selection settings 303 are added or deleted by the auto-selection setting unit 10521 when the user presses an Add button 304 or a Delete button 305. The determining conditions to be set can be a print module name, a print job name, and characters in a page. For the determining conditions, only a print module name may be set, or only a print job name may be set, or only characters in a page may be set. Alternatively, a combination of those conditions may be set. The setting UI 300 further includes a page layout 306, a printing method 307, a color mode 308, and an OK button 309.

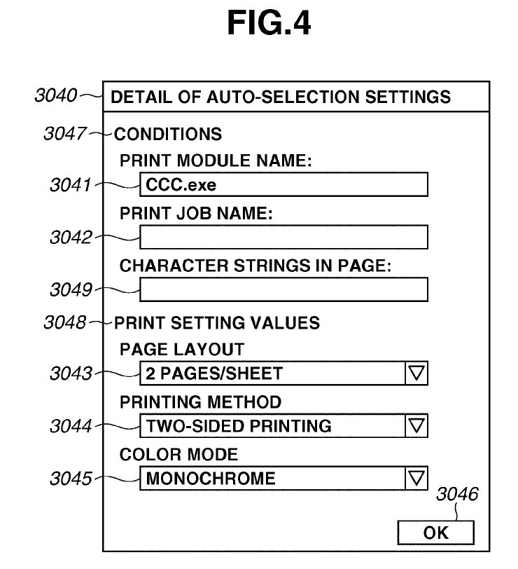

FIG. 4 illustrates an example of an auto-selection setting detail dialog 3040, which is used to add an auto-selection setting to the auto-selection settings 303.

To put differently, FIG. 4 illustrates an example of a user interface displayed on the monitor 110 illustrated in FIG. 1. In this example, when a user presses the Add button 304 on the auto-selection setting unit 10521 illustrated in FIG. 2, the user interface displays an auto-selection detail dialog box 3040 as illustrated in FIG. 4.

In the present exemplary embodiment, in the auto-selection setting detail dialog box 3040, the determining conditions 3047 can be set, and the print setting values 3048 can be set, which become applicable candidates when the conditions are met.

In FIG. 4, the auto-selection setting detail dialog box 3040 includes input fields for the print module name 3041, the print job name 3042, and character strings 3049 in a page. When the determining conditions 3047 are input in a plurality of fields by the user, if newly obtained conditions and the current conditions completely agree with each other, the intended printing application-based setting unit 10532 determines that the new conditions are met.

Combo boxes for a page layout 3043, a printing method 3044, and a color mode 3045 are provided as an input unit to receive print setting values 3048 as applicable candidates when the determining conditions 3047 are met.

In the present exemplary embodiment, the page layout 3043 includes options, such as one page/sheet, two pages/sheet, and four pages/sheet. The printing method 3044 includes options, such as one-sided printing and two-sided printing.

The color mode 3045 includes monochrome printing and color printing.

In the auto-selection detail dialog box 3040, when a user presses the OK button 3046, the auto-selection setting unit 10521 closes the auto-selection setting detail dialog box 3040.

The auto-selection setting unit 10521 stores the set determining conditions 3047 for an intended printing application and the print setting values 3048, which become applicable candidates when those conditions are met, in the external storage device 105 as part of the auto-selection condition and setting 10522.

Finally, the auto-selection setting unit 1052 adds and displays on the setting UI 300 the determining conditions 3047 for an intended printing application and the print setting values 3048, which are applicable candidates when those conditions are met, as a new auto-selection setting 303.

On the other hand, in the setting UI 300 illustrated in FIG. 3, the auto-selection setting unit 10521 can detect that the Delete button 305 has been pressed by the user under the condition that one of the auto-selection settings 303 has been selected by the user. Then, the auto-selection setting unit 10521 deletes the auto-selection setting selected by the user from the external storage device 105.

Further, the auto-selection setting unit 10521 deletes the selected auto-selection setting from the displayed image on the setting UI 300.

The setting UI 300 displayed by the auto-selection setting unit 10521 includes combo boxes for the page layout 306, the printing method 307, and the color mode 308 as an input unit to receive print setting values when the conditions corresponding to the auto-selection setting 300 are not met.

In the present exemplary embodiment, the page layout 306 includes options, such as one page/sheet, two pages/sheet, and four pages/sheet. The printing method 307 includes options, such as one-sided printing and two-sided printing.

The color mode 308 includes monochrome printing and color printing. The auto-selection setting unit 10521 detects the OK button 309 on the setting UI pressed, and stores print setting values not corresponding to the conditions, which have been input in the settings 306 to 308, as a part of the auto-selection condition and setting 10522 in the external storage device 105. Then, the auto-selection setting unit 10521 closes the setting UI 300 displayed on the monitor 110, thus ending the UI control.

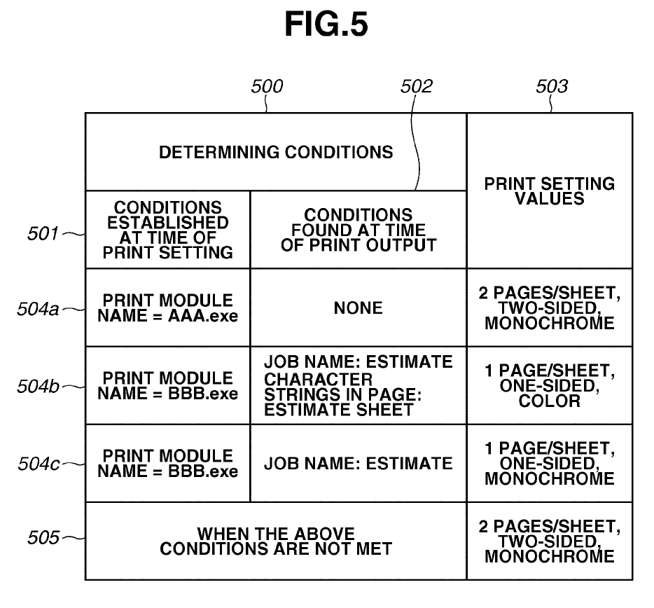

FIG. 5 is a diagram illustrating the relationship between the determining conditions and the print setting values stored in the external storage device 105.

This example illustrates a case of “auto-selection condition and setting 10522” in FIG. 2, which is stored in the external storage device 105 by the auto-selection setting unit 10521.

As illustrated in FIG. 5, in the present exemplary embodiment, the auto-selection condition and setting 10522 includes the determining conditions 500, which are used to infer an intended printing application, and the print setting values 503, which are applicable candidates when the conditions are met.

The determining conditions 500 for inferring an intended printing application are divided into the conditions 501 which are established at the time of print setting on the UI, and the conditions 502 which are found at the time of print output.

The conditions 501 which are established at the time of print setting on the UI include a print module name. The conditions 502 which are found at the time of print output include a print job name and character strings in a page.

In the example illustrated in FIG. 5, the auto-selection settings 303a to 303c on the setting UI 300 by the auto-selection setting unit 10521 are stored as the auto-selection settings 504a to 504c.

As illustrated in the auto-selection settings 504b and 504c, some of the conditions may be the same. More specifically, in this case, in some setting items, the conditions have the same print module name of “BBB.exe” and the same job name of “estimate”, but they are different in respect of character strings in a page. When an intended printing application is inferred, there is a possibility that the intended printing application is inferred based on a simple condition 504c in preference to a more complex condition 504b if the simple condition appears earlier.

Therefore, when storing data in the external storage device 105, the auto-selection setting unit 10521 performs a sorting process as follows.

The auto-selection setting unit 10521 sorts auto-selection setting conditions based on a determining condition from which an intended printing application is inferred earlier. Then, the auto-selection setting unit 10521 sorts “auto-selection setting conditions”, which have the same condition as in the last sorting, by using a next determining condition. In the foregoing cases of sorting, an auto-selection setting condition, with no condition attached, should appear in the last place.

In the present exemplary embodiment, the determining conditions are sorted by a print module name, and those auto-selection setting conditions having a condition of the same print module name are sorted by a condition of a job name, and are finally sorted by a condition of a character string in a page.

A print setting value which does not match the conditions in the auto-selection setting fields 504a to 504c corresponding to print settings on the setting UI 300 by the auto-selection setting unit 10521 is stored in a setting field 505. The print settings include a page layout 306, a printing method 307, and a color mode 308.

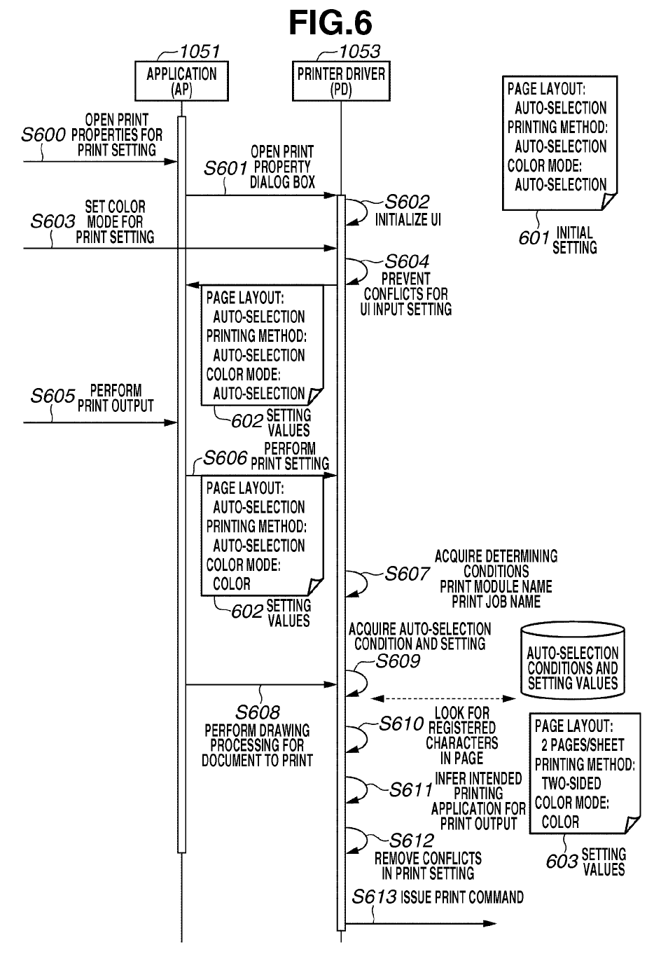

FIG. 6 illustrates an example of a printing control sequence of an entire printing operation in the information processing apparatus according to the present exemplary embodiment. This example illustrates a processing sequence of the printing operation when a user opens the print property dialog box, changes the color mode to color printing under the conditions of the auto-selection setting condition 504a, and then carries out printing. The flow of print setting and print output processing between the application software 1051 and the printer driver 1053 will be described below, in which the application software 1051 and the printer driver 1053 are abbreviated as AP 1051 and PD 1053.

The AP 1051 is driven by the OS and displayed on the monitor 110. The AP 1051 performs a printing process in response to operations on the keyboard 108 or the pointing device 109, such as mouse, by the user.

According to the printing process, the AP 1051 calls an Application Program Interface (API) provided by the OS. In reply to the call, the PD 1053 operates after it is loaded in the process of the print module of the application by the OS function as occasion demands.

In step S600, the AP 1051 receives an instruction to open the print property dialog box from the user. In step S601, the AP 1051 gives the PD 1053 a command to open the print property dialog box.

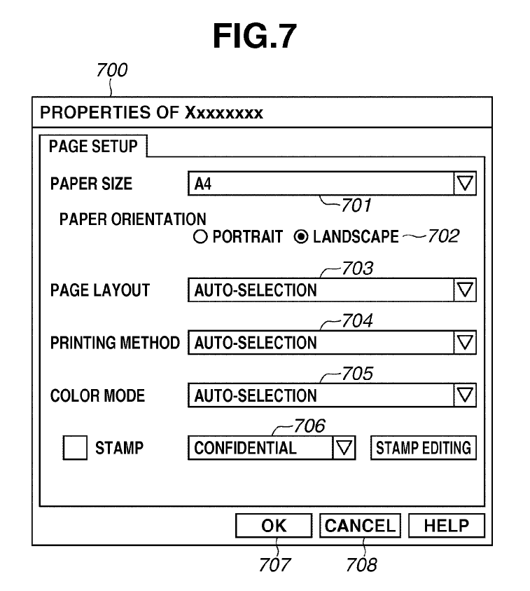

In step S602, the PD 1053, by using the user interface unit 10531, initialize the print property dialog box 700, an example of which is illustrated in FIG. 7.

FIG. 7 illustrates an example of a user interface displayed on the monitor 110 in FIG. 1. This example depicts the print property dialog box 700 by the PD 1053.

In this example, the print property dialog box 700 includes such setting items as a paper size 701, a paper orientation 702, a page layout 703, a printing method 704, a color mode 705, and a stamp 706. The page layout function 703 includes conventional options, such as one page/sheet, two pages/sheet, and four pages/sheet.

The printing method 704 includes conventional options, such as one-sided printing and two-sided printing. The color mode 705 includes conventional options, such as monochrome printing and color printing.

In the present exemplary embodiment, the page layout 703, the printing method 704, and the color mode 705 are each provided with a specific option called “auto-selection”, in which the PD 1053 infers an intended application of a print job.

In step S602, the PD 1053, by using the user interface unit 10531, displays the print property dialog box 700 offering “auto” selection states in the initializing process.

The PD 1053 holds a print setting value 601 in the initial state, so that the page layout 703, the printing method 704, and the color mode 705 are each set in “auto-selection” state.

In response to a changeover from “auto-selection” to color printing in the combo box in the color mode 705 in the print property dialog box from the user, the PD 1053 changes the color mode of the print setting value 601 to color printing.

Further, the PD 1053 detects the press of the OK button 707 by the user in the print property dialog box 700. In step S604, the PD 1053, by using the user interface unit 10531, performs a conflict preventive process in the UI input setting to prevent conflicts in a plurality of setting values.

Then, the PD 1053 supplies the AP 1051 with print setting values 602, including “auto-selection” in the page layout, “auto-selection” in the printing method, and color printing in the color mode.

In step S605, the AP 1051 receives an instruction to execute printing from a user. In step S606, the AP 1051, by using the print setting values 602, performs print settings for the PD 1053. At this time, the AP 1051 sets a print job name. Then, in step S607, to infer an intended printing application, the PD 1053, by using the API supplied by the OS, acquires a print module name, which is a loaded process, and a print job name as determining conditions. An application can be identified from a print module name, and an intended printing application can be inferred.

Subsequently, in step S608, the AP 1051 request the PD 1053 to perform drawing processing for character strings, graphics, and bitmap images in a document to print. In step S609, the PD 1053, by using the intended printing application-based setting unit 10532, reads the auto-selection condition and setting 10522 from the external storage device 105.

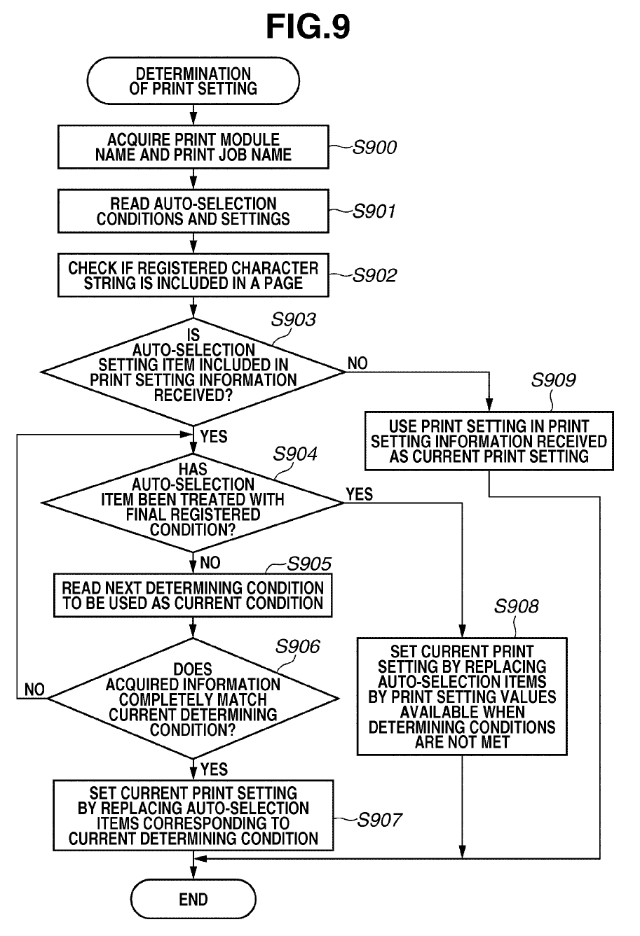

In step S610, the PD 1053 determines whether character strings registered in the auto-selection condition and setting 10522 are included in the drawn images in a page. Then, in step S611, the PD 1053, by using the intended printing application-based setting unit 10532, executes an auto-selection determining process at printing illustrated in FIG. 9 to determine print setting values 602 which are set by auto-selection.

In this example, the above case corresponds to the condition 504a illustrated in FIG. 5, and the page layout and the printing method, which are set by “auto-selection” in the print setting values 602, are determined to be two pages/sheet and two-sided printing, respectively.

Then, in step S603, the color mode intentionally changed by the user in the print property dialog box 700 is kept in the state of color printing. Detail of the inference process is described below with reference to FIG. 9.

In step S612, to eliminate conflicts among the print setting values from the print setting values 602 determined in step S611, the PD 1053 performs a conflict removing process on the print setting values. In step S613, according to the print setting values 602, the PD 1053 issues a print command using the print command generating unit 10534.

In the present exemplary embodiment, as has been described referring to an example of the print control sequence at printing, when a user intentionally sets the print setting values by opening the print property dialog box 700, the print setting values are maintained as they are.

With regard to the print setting items, which have not been set by the user and left to be set by auto-selection, the intended printing application-based setting unit 10532 infers an intended printing application and determines print setting values.

In the above sequence example, the print property dialog box 700 is opened and the color mode is changed. However, for example, it is possible to perform printing with the initial print settings without opening the print property dialog box 700. In this case, the page layout, printing method, and the color mode are determined based on the inference of an intended printing application.

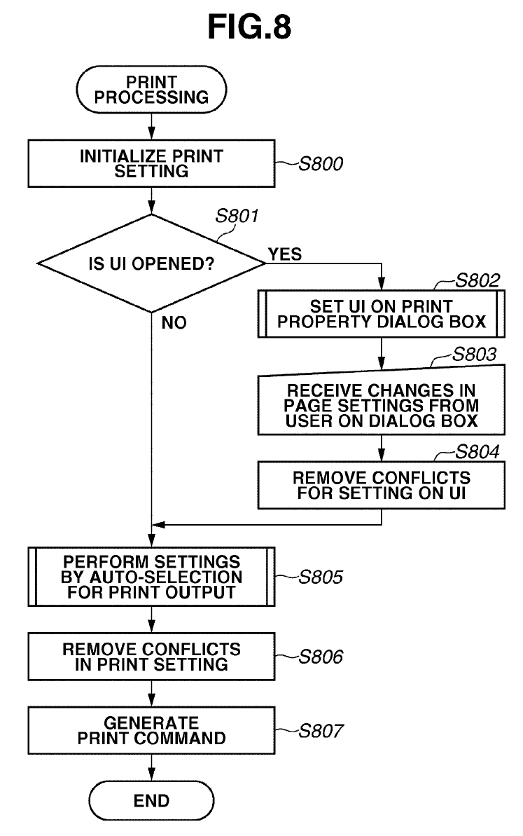

FIG. 8 is a flowchart illustrating an example of a data processing procedure in the information processing apparatus according to the present exemplary embodiment. This example illustrates a series of steps of printing control from print setting to generation of a print command. Those steps are realized when the CPU 101 loads the operating system (OS) 1054 and the printer driver 1053 from the external storage device 105 into the RAM 103 and executes them.

In step S800, the PD 1053, by using the user interface unit 10531, sets the page layout, printing method, and color mode in the print setting information to “auto-selection”, so that the UI is initialized in the print setting function.

In step S801, the PD 1053 determines whether a request has arrived from the AP 1051 to open the print property dialog box. If the PD 1053 determines that it is requested that the print property dialog box should be opened, the process advances to step S802. If it is determined otherwise, the process proceeds to step S805.

In step S802, in the process at setting the UI, the PD 1053, by using the user interface unit 10531, displays the print property dialog box 700, illustrated in FIG. 7, on the monitor 110. In the print property dialog box 700, the page layout 703, the printing method 704, and the color mode 705 are displayed in “auto-selection” state.

In step S803, on the print property dialog box 700, the PD 1053 detects input of information from the user that settings are to be changed. When it is detected that the user presses the OK button 707, as illustrated in FIG. 7, on the print property dialog box 700, the process advances to step S804. In step S804, the PD 1053, by using the user interface unit 10531, performs a conflict removing process to prevent conflicts among a plurality of setting values in print setting by input on the UI.

In step S805, the PD 1053 receives print setting information from the AP 1051. The PD 1053, by using the intended printing application-based setting unit 10532, executes an auto-selection determining process at printing as illustrated in FIG. 9 and determines items to be set by “auto-selection” in the print setting information received from the AP 1051. Detail of the process of inferring an intended printing application will be described below referring to FIG. 9.

In step S806, the PD 1053 performs a conflict removing process to eliminate conflicts in setting from the print setting information. In step S807, the PD 1053, by using the print command generating unit 10534, generates a print command. Then, this process ends.

FIG. 9 is a flowchart illustrating a data processing procedure in the information processing apparatus according to the present exemplary embodiment. This example illustrates a process which infers an intended printing application at the time of print output and determines print settings. Those steps are realized as the CPU 101 loads the OS 1054 and the printer driver 1053 from the external storage device 105 into the RAM 103 and executes them.

In step S900, to infer an intended printing application, the PD 1053, by using the API supplied by the OS, acquires a print module name, as a process including the PD 1053, and a print job name.

In step S901, the PD 1053, by using the intended printing application-based setting unit 10532, reads the auto-selection condition and setting 10522 from the external storage device 105. Then, in step S902, the PD 1053, by using the intended printing application-based setting unit 10532, checks whether character strings registered in the auto-selection condition and setting 10522 are included in the drawn images in a page.

In step S903, the PD 1053, by using the intended printing application-based setting unit 10532, determines whether setting items to be set by auto-selection are included in the print setting information received from the AP 1051. If the PD 1053 determines that there is at least one setting item to be set by auto-selection, to determine a print setting value, the process advances to step S904, or if the PD 1053 determines that setting items to be set by auto-selection are not included, the process advances to step S909.

In step S904, the PD 1053, by using the intended printing application-based setting unit 10532, determines whether the final determining condition, registered in the auto-selection condition and setting 10522, has been checked. If the PD 1053 determines that the final determining condition has been checked, the process advances to step S908, or if the PF 1053 determines that the final determining condition has not yet been checked, the process advances to step S905.

In step S905, the PD 1053, by using the intended printing application-based setting unit 10532, acquires the next determining condition to be used as the current determining condition. To use the auto-selection conditions and setting values illustrated in FIG. 5, for example, the PD 1053 selects conditions out of the unchecked auto-selection setting conditions 504a to 504c in an order from the top downward in the table, and sets the selected condition as the current determining condition.

In step S906, the PD 1053 determines whether the conditions, such as a print module name, a print job name acquired in step S900, and character strings in a page checked in step S902 all agree with the corresponding current determining condition. If the PD 1053 determines that the conditions completely agree with each other, the process advances to step S907, and if the PD 1053 determines that not all conditions completely agree, the process proceeds to step S904.

In step S907, the PD 1053, by using the intended printing application-based setting unit 10532, replaces the auto-selection setting items in the print setting information, received from the AP 1051, with print setting values as setting candidates when the current determining conditions are met. Then, the PD 1053 uses the print setting information after some replacements as the current setting information. Then, this process ends.

On the other hand, when the process advances from step S904 to step S908, the PD 1053, by using the intended printing application-based setting unit 10532, replaces the setting items, which are to be set by auto-selection in the print setting information received from the AP 1051, by setting values 505 to be used when auto-selection setting values do not match the conditions for inferring an intended printing application. The PD 1053 uses print setting information after the replacement as the current print setting information. Then, this process ends.

When the process advances from step S903 to step S909, setting items to be set by auto-selection are not included in the print setting information received from the AP 1051. Therefore, the PD 1053 uses the received print setting information as the current print setting information. Then, this process ends.

In the first embodiment, by executing the process illustrated in FIG. 9, with regard to the print setting items to be set by auto-selection, which have not been changed intentionally by the user, print setting items can be determined by inferring an intended printing application.

According to the first exemplary embodiment, when the print setting UI in ordinary printing is not opened, print setting values are set automatically according to the conditions, or when the print setting UI is opened and print setting values are set by the user, printing can be performed according to the set conditions.

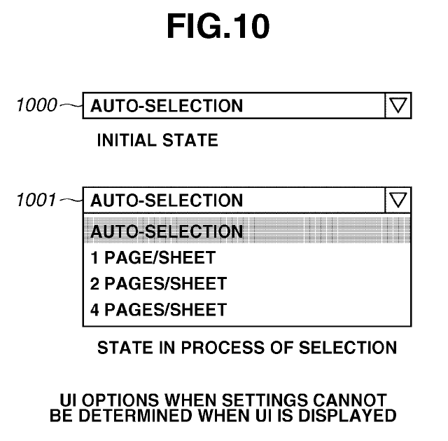

FIG. 10 is a diagram illustrating a part of the user interface illustrated in FIG. 7. This example indicates the initial status 1000 and the selection-in-progress status of the combo box 703 of the page layout function in the print property dialog box 700.

In the first exemplary embodiment, the print setting items specified as “auto-selection”, are determined by inferring an intended printing application at print output. Further, in the first exemplary embodiment, it is never determined to set “auto-selection” for the print setting items in print setting. In contrast, in a second exemplary embodiment of the present invention, if the conditions are met for inferring an intended printing application when the print property dialog box 700 is opened, print setting items, for which “auto-selection” is set, are determined.

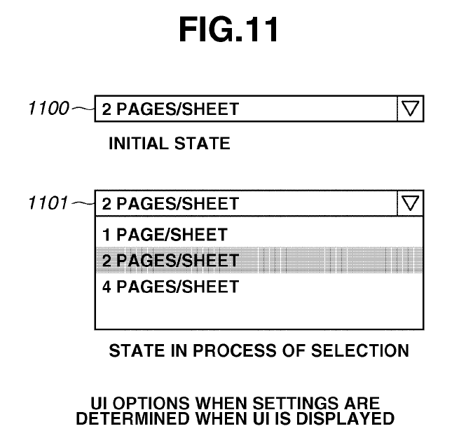

FIG. 11 is a diagram illustrating a part of the user interface illustrated in FIG. 7. This example indicates the initial status 1100 and the selection-in-progress status of the combo box 703 in the page layout when the print property dialog box 700 is opened by a print module name of AAA.exe under the determining conditions 500 for inferring an intended printing application.

In FIG. 11, as indicated by the initial status 1100, because the condition of auto-selection setting 504a is met, a page layout of two pages/sheet is selected in the initial status in the combo box of the page layout. As indicated by the selection-in-progress status, “auto-selection” is not displayed as an option.

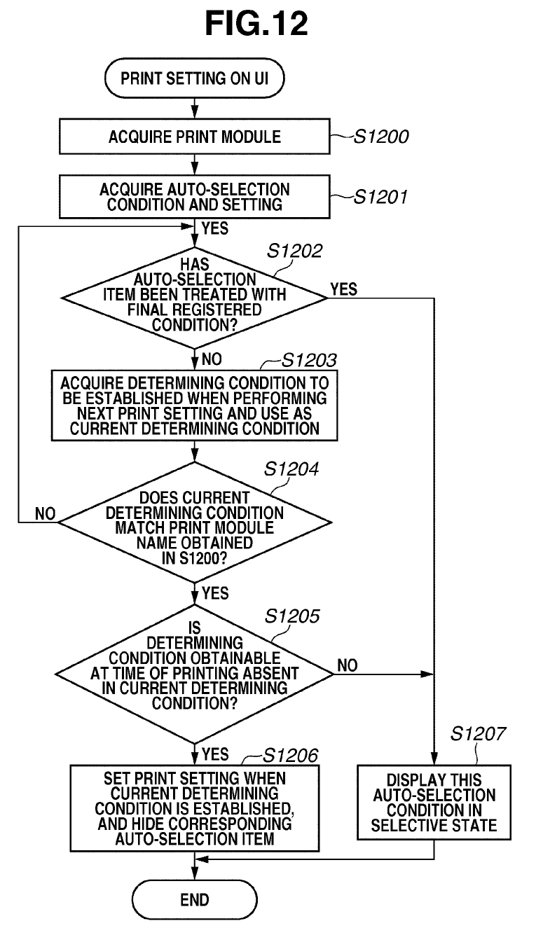

Referring to FIG. 12, description is made of a process for determining print setting by inferring an intended printing application at print setting in the second exemplary embodiment using FIG. 11.

FIG. 12 is a flowchart illustrating an example of a data processing procedure in an information processing apparatus according to the second exemplary embodiment. This example indicates a process of determining print settings by inferring an intended printing application when performing next print settings. The steps are realized when the CPU 101 loads the OS 1054 and the printer driver 1053 from the external storage device 105 into the RAM 103 and executes them.

In step S1200, to infer an intended printing application, the PD 1053, by using the API supplied by the OS, acquires a print module name as a process including the PD 1053. In step S1201, the PD 1053, by using the intended printing application-based setting unit 10532, reads the auto-selection condition and setting 10522 from the external storage device 105.

In step S1202, the PD 1053, by using the intended printing application-based setting unit 10532, determines whether the final determining condition registered in the auto-selection condition and setting 10522 has been checked. If the PD 1053 determines that the final determining condition has been checked, the process advances to step S1207. If the PD 1053 determines that the final determining condition has not yet been checked, the process advances to step S1203.

In step S1203, the PD 1053, by using the intended printing application-based setting unit 10532, acquires the next condition to be used as the current condition when fixing a determining condition which corresponds to a print setting value. To take the “auto-selection conditions and setting values” indicated in FIG. 5 for example, a determining condition, which is acquired in the first place and fixed for print setting, is AAA.exe of the condition 504a, and the next condition 504b is BBB.exe, and the condition 504c having the same module name of BBB.exe is skipped and not acquired.

In step S1204, the PD 1053, by using the intended printing application-based setting unit 10532, determines whether the print module name acquired in step 1200 agrees with the module name in the current determining condition. If the PD 1053 determines that they agree with each other, the process proceeds to step S1205, and if the PD 1053 determines that they do not agree with each other, the process proceeds to step S1202.

In step S1205, the PD 1053, by using the intended printing application-based setting unit 10532, determines whether the current determining condition includes a condition which is found at the time of print output. If the PD 1053 determines that there is not a condition that is found at print output, the PD 1053 proceeds to step S1206, or if the PD 1053 determines that there is a condition that is found at print output, because this condition cannot be determined at the time of print setting, the process advances to step S1207.

In step S1206, the PD 1053, by using the intended printing application-based setting unit 10532, sets a print setting value when the current determining condition is met, in the print setting information. Furthermore, the PD 1053 uses the initial value status in the combo box in the print property dialog box 700 as a print setting value when the current determining condition is met, and sets its option in the selected status. The PD 1053 hides an option of auto-selection from a list of options displayed in the middle of selection.

On the other hand, if the process advances from step S1202 or S1205 to step S1207, the PD 1053 sets the initial status of the combo box in the print property dialog box 700 to auto-selection, which is then put in the selected status.

In the second exemplary embodiment, if the condition for inferring an intended printing application is met when the print property dialog box 700 is opened, the PD 1053 determines and displays print setting items. This enables print setting values to be indicated clearly, which are set by inferring the intended printing application before print output is performed.

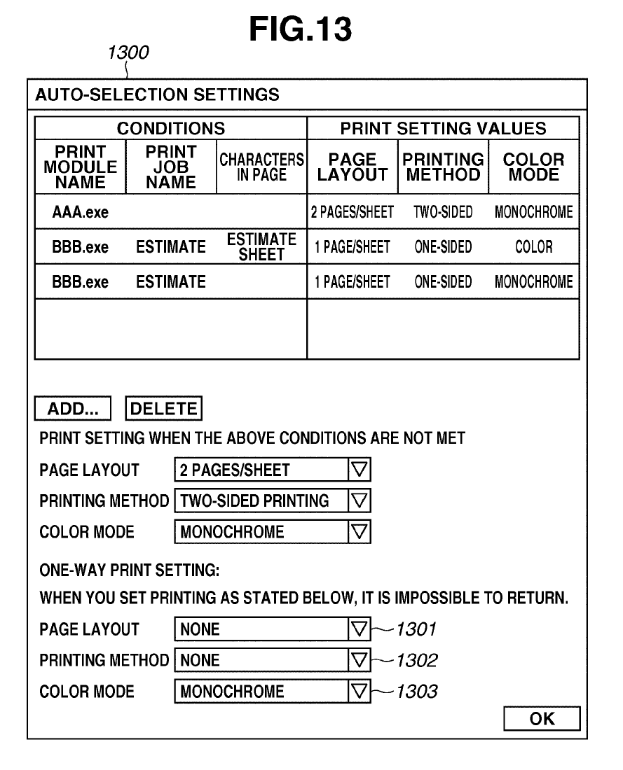

FIG. 13 is a diagram illustrating another example of the user interface illustrated in FIG. 7. This example indicates the setting UI 300 of the auto-selection setting unit 10521.

In a third exemplary embodiment of the present invention, the page layout 1301, the printing method 1302, and the color mode 1303 can be set in one-way print setting. The one-way print setting functions as a parameter for restricting setting values of a part of the “auto-selection” items in initial setting, according to the administrator's intention.

The page layout 1301 has options including one page/sheet, two pages/sheet, four pages/sheet, and none. The printing method 1302 has options including one-sided printing, two-sided printing, and none. The color mode 1303 has options including monochrome printing, color printing, and none.

If, for the print setting values set in the one-way print setting, the page layout 703, the printing method 704, and the color mode 705 are set as print setting items on the print property dialog box 700, it is difficult to change over to other options.

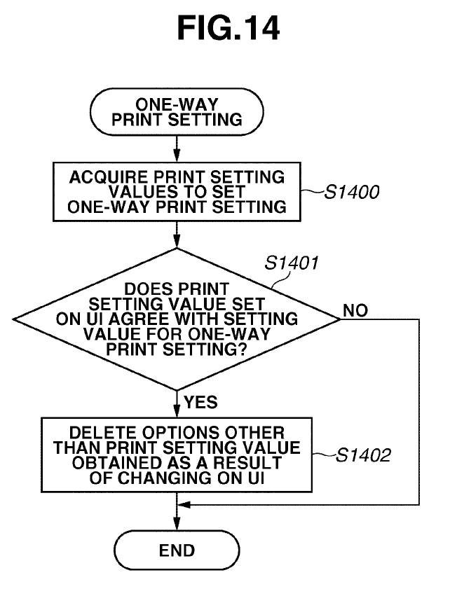

FIG. 14 is a flowchart illustrating an example of a data processing procedure in an information processing apparatus according to the third exemplary embodiment. This example indicates a process of one-way print setting in printing control. This process is executed when the print setting items 703 to 705 in the print property dialog box 700 are changed. Those steps are realized when the CPU 101 loads the OS 1054 and the printer driver 1053 from the external storage device 105 into the RAM 103 and executes them.

In step S1400, the PD 1053, by using the intended printing application-based setting unit 10532, reads one-way print setting values. In step S1401, the PD 1053 determines whether the print setting values changed via the print property dialog box 700 agree with one-way print setting values. If the PD 1053 determines that both setting values agree with each other, the PD 1053 proceeds to step S1402, or if the PD 1053 determines that those setting values do not agree, this process ends.

In step S1402, the PD 1053 deletes options other than the print setting values changed in the print property dialog box 700, which agree with the one-way print setting values, to ensure that the options are selected. Then, this process ends.

According to the present exemplary embodiment, once a one-way print setting value is selected, it become impossible to change the corresponding print setting value. Therefore, chances are high for a user to select print setting values, which the administrator recommends, to reduce TCO and protect ecological systems.

The present invention can be implemented by performing processing, in which software (program) to realize the function of the exemplary embodiments described above is supplied to a system or an apparatus via a network or various types of storage media, and the computer (or the CPU or MPU) of the system or apparatus reads and executes the program.

According to an exemplary embodiment of the present invention, when the print setting UI in ordinary printing is not opened, print setting values are set automatically according to conditions, or when a user opens the print setting UI and performs settings, printing takes place according to setting conditions.

By a simple operation, print settings can be made according to initial settings in a manner adaptable for the determining conditions in a job, and print settings can be changed to meet the user's requests.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-322105 filed Dec. 18, 2008, which is hereby incorporated by reference herein in its entirety.

What is claimed is:

1. An information processing apparatus including a printer driver configured to generate a job to be output to a printing apparatus, the information processing apparatus comprising:
a print setting unit configured to perform print setting using a function of performing initially-set print setting by inferring an intended printing application according to a determining condition obtained from the job or a function of allowing a user to perform print setting to the job;
a determination unit configured to determine whether a user interface operable to change the initially-set print setting is requested from the user; and
a control unit configured to process the job based on print setting values changed via the user interface if the determination unit determines that the user interface is requested from the user, and to process the job according to the function of performing initially-set print setting by inferring an intended printing application according to a determining condition obtained from the job if the determination unit determines that the user interface is not requested from the user.

2. The information processing apparatus according to claim 1, wherein the print setting unit is configured to acquire a print module name used to start the printer driver, a print job name, and a character string in a print page as the determining condition.

3. The information processing apparatus according to a claim 1, wherein the print setting unit is configured to set a print setting value by which to restrict the user's selection when the user performs the function of print setting by inferring the intended printing application.

4. A print control method for an information processing apparatus including a printer driver configured to generate a job to be output to a printing apparatus, the print control method comprising:
performing print setting using a function of performing initially-set print setting by inferring an intended printing application according to a determining condition obtained from the job or a function of allowing a user to perform print setting to the job;
determining whether a user interface operable to change the initially-set print setting is requested from the user; and
processing the job based on print setting values changed via the user interface if it is determined that the user interface is requested from the user, and processing the job according to the function of performing initially-set print setting by inferring an intended printing application according to a determining condition obtained from the job if it is determined that the user interface is not requested from the user.

5. The print control method according to claim 4, further comprising acquiring a print module name used to start the printer driver, a print job name, and a character string in a print page as the determining condition.

6. The print control method according to claim 4, further comprising setting a print setting value by which to restrict the user's selection when the user performs the function of print setting by inferring the intended printing application.

7. A storage medium storing a program for causing a computer to perform a method comprising:
displaying a setting screen on which a specific setting value is set corresponding to one of a print module name, a print job name, and characters in a page is displayed as an initial value and the specific setting value is allowed to be changed by a user; and
when the specific setting value is not changed via the setting screen, setting a setting value corresponding to one of the print module name, the print job name, and the characters in a page, and when the specific setting value is changed, setting the changed setting value.
